(19) United States
(12) Patent Application Publication
(10) Pub. No.: US 2026/0024779 A1
(43) Pub. Date: Jan. 22, 2026

(54) MEMBRANE ELECTRODE ASSEMBLY AND FUEL CELL

(71) Applicant: TOYOTA JIDOSHA KABUSHIKI KAISHA, Toyota-shi Aichi-ken (JP)

(72) Inventors: Shunsuke TAKAHASHI, Susono-shi Shizuoka-ken (JP); Keiichi OKUBO, Susono-shi Shizuoka-ken (JP)

(73) Assignee: TOYOTA JIDOSHA KABUSHIKI KAISHA, Toyota-shi Aichi-ken (JP)

(21) Appl. No.: 19/254,740

(22) Filed: Jun. 30, 2025

(30) Foreign Application Priority Data
Jul. 18, 2024 (JP) 2024-114639

(51) Int. Cl. H01M 4/86; H01M 4/92; H01M 8/10; H01M 8/1004

(52) U.S. Cl. CPC H01M 4/8652; H01M 4/8605; H01M 4/8663; H01M 4/92; H01M 8/1004; H01M 2008/1095

(57) ABSTRACT

A membrane electrode assembly includes a solid polymer electrolyte membrane, an anode catalyst layer disposed on a first surface of the solid polymer electrolyte membrane, and a cathode catalyst layer disposed on a second surface of the solid polymer electrolyte membrane, the membrane electrode assembly includes a metal ion selected from a cerium ion and a manganese ion; and a host compound capable of forming a clathrate compound together with the metal ion. The cathode catalyst layer contains an electrode catalyst, and an ionomer, the electrode catalyst is a metal supported catalyst containing a catalyst metal, and a support supporting the catalyst metal, and an ionomer coverage ratio of the catalyst metal in the cathode catalyst layer is 40% or less.

### CROSS-REFERENCE TO RELATED APPLICATION

This application claims priority to Japanese Patent Application No. 2024-114639 filed on Jul. 18, 2024, incorporated herein by reference in its entirety.

### BACKGROUND

### 1. Technical Field

The present disclosure relates to a membrane electrode assembly and a fuel cell.

### 2. Description of Related Art

A polymer electrolyte fuel cell is generally provided with a membrane electrode assembly (also referred to as an “MEA”) including a solid polymer electrolyte membrane that is an electrolyte membrane; an anode catalyst layer disposed on one surface of the solid polymer electrolyte membrane; and a cathode catalyst layer disposed on the other surface of the solid polymer electrolyte membrane. The anode catalyst layer functions as a fuel electrode, and the cathode catalyst layer functions as an air electrode. On the both surfaces of the MEA, gas diffusion layers are further disposed in some cases, which configuration is designated as a membrane electrode & gas fusion layer assembly (also referred to as a “MEGA”). Here, in the polymer electrolyte fuel cell, hydrogen peroxide (H₂O₂) may be generated from water and oxygen, or a hydroxyl radical (·OH) may be generated from hydrogen peroxide in some cases in the catalyst layers at the time of power generation. The hydrogen peroxide and the hydroxyl radical can be a cause of deteriorating an electrolyte resin such as an ionomer contained in the solid polymer electrolyte membrane or the catalyst layers.

Therefore, a technique to make harmless a hydrogen peroxide and a hydroxyl radical generated during power generation of the fuel cell by containing a radical quencher such as a cerium ion in the MEA has been proposed. For making a hydrogen peroxide and a hydroxyl radical harmless, for example, a reaction from the hydrogen peroxide and the hydroxyl radical to water is performed.

For example, Vo Dinh Cong Tinh et al., “Enhancement of oxidative stability of PEM fuel cell by introduction of HO radical scavenger in Nafion ionomer”, Journal of Membrane Science 613 (2020) 118517 has disclosed a membrane electrode assembly (MEA) in which a coordination complex of 18-crown-6-ether/cerium ion (CRE/Ce) is embedded in a Nafion ionomer disposed between a catalyst and a membrane. It is described that Ce plays a role of capturing a HO-radical, and that CRE reduces elution of a cerium ion from the MEA during an operation of the cell (Abstract and the like).

### SUMMARY

As described above, Vo Dinh Cong Tinh et al., “Enhancement of oxidative stability of PEM fuel cell by introduction of HO radical scavenger in Nafion ionomer”, Journal of Membrane Science 613 (2020) 118517 has disclosed an anode catalyst layer containing a cerium ion as a radical quencher and 18-crown-6-ether. One of problems of a cerium ion is durability deterioration in accordance with concentration reduction due to movement of the ion, but Vo Dinh Cong Tinh et al., “Enhancement of oxidative stability of PEM fuel cell by introduction of HO radical scavenger in Nafion ionomer”, Journal of Membrane Science 613 (2020) 118517 has described that elution of the cerium ion to the outside of the MEA can be reduced by adding 18-crown-6-ether.

When research was made by using a membrane electrode assembly containing a radical quencher such as a cerium ion, and a crown ether compound such as 18-crown-6-ether, however, it was found that the initial voltage is reduced, and there is a room of improvement in the performance.

Therefore, an object of the present disclosure is to provide a membrane electrode assembly desirable in durability and performance.

The voltage is reduced because the crown ether compound contained in the anode catalyst layer, the electrolyte membrane, or the like of the membrane electrode assembly moves to the cathode catalyst layer, and poisons the cathode catalyst, or reduces proton conductivity in the ionomer of the cathode. When an ionomer coverage ratio of a catalyst metal in the cathode catalyst layer is adjusted to be equal to or lower than a prescribed value, not only voltage reduction caused during the use but also reduction of the initial voltage can be suppressed.

Therefore, examples of aspects of the present embodiment are as follows:
(1) A membrane electrode assembly including a solid polymer electrolyte membrane, an anode catalyst layer disposed on a first surface of the solid polymer electrolyte membrane, and a cathode catalyst layer disposed on a second surface of the solid polymer electrolyte membrane, including: a metal ion selected from a cerium ion and a manganese ion; and a host compound having an ability of forming a clathrate compound together with the metal ion, wherein: the cathode catalyst layer contains an electrode catalyst, and an ionomer; the electrode catalyst is a metal supported catalyst containing a catalyst metal, and a support supporting the catalyst metal; and an ionomer coverage ratio of the catalyst metal in the cathode catalyst layer is 40% or less.
(2) The membrane electrode assembly according to (1), wherein the host compound may be a crown ether compound or a salt thereof.
(3) The membrane electrode assembly according to (1) or (2), wherein the host compound may have a molecular weight of 300 or more.
(4) The membrane electrode assembly according to any one of (1) to (3), wherein the host compound may be a crown ether compound having an aromatic ring or an aliphatic ring, or a salt thereof.
(5) The membrane electrode assembly according to any one of (1) to (4), wherein the ionomer may contain a perfluorosulfonic acid polymer.
(6) The membrane electrode assembly according to any one of (1) to (5), wherein the ionomer may contain a fluorine resin-based ionomer having a sulfonic acid group-containing side chain represented by the following general formula:

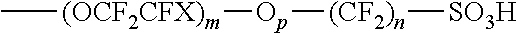

wherein m represents an integer of 0 to 3, n represents an integer of 0 to 12, p represents 0 or 1, and X represents a fluorine atom or a trifluoromethyl group.
(7) The membrane electrode assembly according to any one of (1) to (6), wherein the catalyst metal of the cathode catalyst layer may contain at least one selected from the group consisting of a platinum particle, a platinum alloy particle, and a composite particle containing platinum.
(8) The membrane electrode assembly according to any one of (1) to (7), wherein the support of the cathode catalyst layer may contain carbon having electronic conductivity or an oxide having electronic conductivity.
(9) The membrane electrode assembly according to any one of (1) to (8), wherein: a pore volume distribution of the metal supported catalyst may have a peak pore size in a range of a pore size of 2.0 nm or more and 12.0 nm or less; and a pore volume of mesopores of 2 nm to 30 nm of the metal supported catalyst may be 1.9 cc/g or more.
(10) A fuel cell including the membrane electrode assembly according to any one of (1) to (9).

The present disclosure can provide a membrane electrode assembly desirable in durability and performance.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic sectional view illustrating a structural example of a membrane electrode assembly and a polymer electrolyte fuel cell of the present embodiment, and is a sectional view of a main part of an exemplified fuel cell.

### DETAILED DESCRIPTION OF EMBODIMENTS

The present embodiment provides a membrane electrode assembly including a solid polymer electrolyte membrane, an anode catalyst layer disposed on one surface of the solid polymer electrolyte membrane, and a cathode catalyst layer disposed on the other surface of the solid polymer electrolyte membrane, in which the membrane electrode assembly contains a metal ion selected from a cerium ion and a manganese ion, and a host compound capable of forming a clathrate compound together with the metal ion, the cathode catalyst layer contains an electrode catalyst and an ionomer, the electrode catalyst is a metal supported catalyst containing a catalyst metal and a support supporting the catalyst metal, and an ionomer coverage ratio of the catalyst metal in the cathode catalyst layer is 40% or less.

The present embodiment can provide a membrane electrode assembly desirable in durability. In the present embodiment, a cerium ion and/or a manganese ion that functions as a radical quencher is added to the membrane electrode assembly (for example, the anode catalyst layer or the solid polymer electrode membrane). Since the cerium ion and/or the manganese ion can capture and make harmless a hydrogen peroxide radical, the deterioration of the membrane electrode assembly can be suppressed. Besides, since the host compound to the metal ion is added to the membrane electrode assembly, the movement of the metal ion can be suppressed, and hence the deviation of the concentration in the plane direction can be reduced. Besides, in the membrane electrode assembly of the present embodiment, since the ionomer coverage ratio in the metal supported catalyst of the cathode catalyst layer is specified to fall in the prescribed range, poisoning of the cathode catalyst by the host compound such as a crown ether compound can be suppressed, and thus, reduction of the initial voltage can be suppressed. For these reasons, the present embodiment can provide a membrane electrode assembly desirable in durability.

Now, the configuration of the present embodiment will be described.

### Membrane Electrode Assembly

The solid polymer electrolyte membrane has functions to prevent passage of an electron and a gas, and to move a proton (H⁺) generated in the anode from an anode-side catalyst layer to a cathode-side catalyst layer. As the solid polymer electrolyte membrane of the present embodiment, any electrolyte membrane having proton conductivity known in this technical field can be used. As the solid polymer electrolyte membrane, for example, a membrane formed from a fluororesin having a sulfonic acid group that is an electrolyte (such as Nafion (manufactured by DuPont), FLEMION (manufactured by AGC Inc.), or Aciplex (manufactured by Asahi Kasei Corporation)) can be used.

The thickness of the solid polymer electrolyte membrane is not especially limited, and is, for example, 5 μm to 50 μm from the viewpoint of improvement of the proton conductivity.

The cathode catalyst layer functions as an air electrode (oxygen electrode). The cathode catalyst layer contains at least an electrode catalyst, and an ionomer as an electrolyte. The electrode catalyst is a metal supported catalyst in which a metal particle having catalytic activity is supported on a support. In other words, the electrode catalyst is a metal supported catalyst containing a catalyst metal, and a support supporting the catalyst metal.

As a method for supporting a catalyst metal on a support, any of conventional methods can be employed. An example includes a method in which a particulate catalyst metal is mixed in a support dispersion in which a support is dispersed, and the resultant is filtered, washed, dispersed again in ethanol or the like, and dried with a vacuum pump or the like. After the drying, the resultant may be subjected to a heat treatment if necessary.

The support is not especially limited, and examples thereof include a carbon or an oxide. The carbon can be a carbon having electronic conductivity. The oxide can be an oxide having electronic conductivity. One of these supports may be singly used, or two or more of these may be used in combination.

Examples of the carbon support include carbon black (such as acetylene black, Ketchen black, or furnace black), activated carbon, graphite, glassy carbon, graphene, carbon fiber, carbon nanotube, carbon nitride, carbon sulfide, and carbon phosphide. One of these carbon supports may be singly used, or two or more of these may be used in combination.

Examples of the oxide support include a titanium oxide, a niobium oxide, a tin oxide, a tungsten oxide, and a molybdenum oxide. One of these oxide supports may be singly used, or two or more of these may be used in combination.

In embodiments, the support is a porous support or a porous carbon support.

The catalyst metal is not especially limited as long as it exhibits catalytic effect in a reaction occurring in an electrode.
air electrode (cathode): O₂+4H⁺+4e⁻→2H₂O
hydrogen electrode (anode): 2H₂→4H⁺+4e⁻

The catalyst metal is not especially limited, and for example, platinum, palladium, rhodium, gold, silver, osmium, iridium, or an alloy of two or more of these can be used. A platinum alloy is not especially limited, and for example, an alloy of platinum with at least one of aluminum, chromium, manganese, iron, cobalt, nickel, gallium, zirconium, molybdenum, ruthenium, rhodium, palladium, vanadium, tungsten, rhenium, osmium, iridium, titanium, and lead can be used. In embodiments, the catalyst metal is at least one selected from the group consisting of a platinum particle, a platinum alloy particle, and a composite particle containing platinum. One of these catalyst metals may be singly used, or two or more of these may be used in combination.

The content of the catalyst metal in the electrode catalyst of the cathode catalyst layer is not limited as long as the above-described catalytic effect is exhibited and the ionomer coverage ratio of the catalyst metal in the cathode catalyst layer falls in the range described below, and is, in embodiments, for example, 20 to 60% by mass, or 35 to 50% by mass based on the total mass of the electrode catalyst. Alternatively, in embodiments, the content of the catalyst metal in the electrode catalyst of the cathode catalyst layer is 0.01 to 2.0 mg/cm², or 0.1 to 0.5 mg/cm² per unit area of the cathode catalyst layer.

In the present embodiment, the metal supported catalyst used has a pore volume distribution having a peak pore size in the range of the pore size of 2.0 nm or more and 12.0 nm or less. When the peak pore size in the pore volume distribution of the metal supported catalyst is 2.0 nm or more, a catalyst particle can be supported in a pore.

In embodiments, the peak pore size of the pore volume distribution is 2.5 nm or more or 3.0 nm or more. In embodiments, the peak pore size of the pore volume distribution is 11.8 nm or less, 11.5 nm or less, 10 nm or less, 8.0 nm or less, 6.5 nm or less, 6.0 nm or less, or 5.5 nm or less.

In embodiments, in the metal supported catalyst used in the present embodiment, the pore volume of mesopores of 2 nm to 30 nm is 1.9 cc/g or more. When the pore volume of the mesopores of 2 nm to 30 nm in the metal supported catalyst is 1.9 cc/g or more, a sufficient amount of catalyst particles can be supported in the pores. In embodiments, the upper limit of the pore volume of the mesopores of 2 nm to 30 nm in the metal supported catalyst is not especially limited, and is 20.0 cc/g or less from the viewpoint of the durability of the metal supported catalyst.

In embodiments, the pore volume of the mesopores of 2 nm to 30 nm is 4.0 cc/g or more, 6.0 cc/g or more, 7.5 cc/g or more, 8.0 cc/g or more, 8.5 cc/g or more, 9.0 cc/g or more, 9.5 cc/g or more, 10.0 cc/g or more, or 10.5 cc/g or more. In embodiments, the pore volume of the mesopores of 2 nm to 30 nm is 18.0 cc/g or less, 16.0 cc/g or less, or 14.0 cc/g or less.

In embodiments, the metal supported catalyst used in the present embodiment has a BET specific surface area of 150 m²/g or more. When the BET specific surface area of the metal supported catalyst is 150 m²/g or more, a supporting ratio can be retained with the particle size of the platinum catalyst suppressed to be small, and pores formed by voids among particles can be increased. In embodiments, the upper limit of the

BET specific surface area of the metal supported catalyst is not especially limited, and is 950 m²/g or less from the viewpoint of the durability of the metal supported catalyst.

In embodiments, the BET specific surface area is 200 m²/g or more, 250 m²/g or more, 300 m²/g or more, 330 m²/g or more, 350 m²/g or more, or 450 m²/g or more. In embodiments, the BET specific surface area is 900 m²/g or less, 850 m²/g or less, 800 m²/g or less, or 750 m²/g or less.

The metal supported catalyst is configured by supporting, on the support, a particulate catalyst metal having catalytic activity. As described above, in embodiments, the support has pores (mesopores), and the particulate catalyst metal is supported in the pores. Besides, at least a part of the catalyst metal may be supported in the pores, and another part thereof may be supported on the surface of the support. In embodiments, from the viewpoint of reducing the ionomer coverage ratio in the cathode catalyst layer, however, the catalyst metal is supported in the pores.

When the metal supported catalyst has the pores and the BET specific surface area as described above, the ionomer coverage ratio of the catalyst metal in the cathode catalyst layer can be appropriately controlled.

In embodiments, the content of the electrode catalyst in the cathode catalyst layer is not especially limited, and is, for example, 3 to 40% by mass, or 5 to 38% by mass based on the total mass of the cathode catalyst layer.

In embodiments, the ionomer used as the electrolyte in the cathode catalyst layer is an ionomer having a sulfonic acid group. An ionomer is also designated as a cation exchange resin, and is present as a cluster formed of ionomer molecules. The ionomer is not especially limited, and for example, any of ionomers known in this technical field can be used. Examples of the ionomer include fluororesin-based ionomers such as a perfluorosulfonic acid polymer; sulfonated resin-based ionomers such as sulfonated polyether ketone, sulfonated polyether sulfone, sulfonated polyether ether sulfone, sulfonated polysulfone, sulfonated polysulfide, and sulfonated polyphenylene; and sulfoalkylated resin-based ionomers such as sulfoalkylated polyether ether ketone, sulfoalkylated polyether sulfone, sulfoalkylated polyether ether sulfone, sulfoalkylated polysulfone, sulfoalkylated polysulfide, and sulfoalkylated polyphenylene. Among these, fluororesin-based ionomers are desired. Besides, in embodiments, the ionomer is a perfluorosulfonic acid polymer, and/or a fluororesin-based ionomer having a sulfonic acid group-containing side chain represented by the following general formula:

-(OCF₂CFX)ₘ-Oₚ-(CF₂)ₙ-SO₃H
wherein m represents an integer of 0 to 3, n represents an integer of 0 to 12, p represents 0 or 1, and X represents a fluorine atom or a trifluoromethyl group.

Examples of such an ionomer include the following:

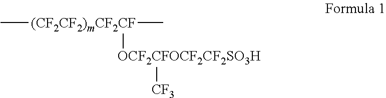

[available as, for example, Nafion (registered trademark) (EW (equivalent weight of ionomer): 1020, m=6.6)]

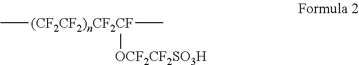

[available as, for example, Aquivion (registered trademark) (EW: 830, n=5.5)]

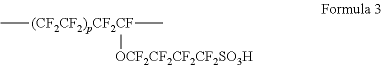

[available as, for example, 3M (trademark) (EW: 850, p=4.7)]

One of these ionomers may be singly used, or two or more of these may be used in combination.

Alternatively, the ionomer may be a fluorine-based ionomer having a highly oxygen permeable sulfonic acid group-containing side chain. Since the highly oxygen permeable ionomer has a cyclic structure, the free volume of molecules is increased, oxygen permeability is improved, and hence the output of a fuel cell obtained therewith can be increased (Japanese Patent Nos. 6211249 and 6763300).

In the present embodiment, the ionomer coverage ratio of the catalyst metal in the cathode catalyst layer is 40% or less, 38% or less, 36% or less, 34% or less, 33% or less, 32% or less, 31% or less, 30% or less, 29% or less, or 28% or less. When the ionomer coverage ratio is 40% or less, voltage reduction can be effectively suppressed, and as the ionomer coverage ratio is lower, the effect is increased. The voltage reduction is suppressed when the ionomer coverage ratio is 40% or less because crown ether having flown from the anode catalyst layer to the cathode catalyst layer can be suppressed from adsorbing onto the surface of the cathode catalyst through the ionomer.

In the present embodiment, the lower limit of the ionomer coverage ratio of the catalyst metal in the cathode catalyst layer is not especially limited. The ionomer coverage ratio of the catalyst metal in the cathode catalyst layer is, for example, 1% or more, 2% or more in one embodiment, 3% or more in another embodiment, 4% or more in another embodiment, and 5% or more in still another embodiment.

The ionomer coverage ratio of the present embodiment is an index indicating a degree at which the catalyst metal of the cathode catalyst layer is covered with the ionomer serving as a proton conductor, and the ionomer coverage ratio θ is defined as follows:

$$θ = {S}_{C - S} / ( {S}_{C - S} + {S}_{C - L} ) \qquad ( 1 )$$

wherein S_{C-S} is an area in which a catalyst metal of a cathode catalyst layer is in contact with a solid proton conductor (namely, the ionomer of the present embodiment), S_{C-L} is an area in which a catalyst metal of a membrane electrode assembly is in contact with a liquid proton conductor (S_{C-L}), the liquid proton conductor connecting the catalyst metal to the solid proton conductor in a state capable of proton conduction.

Referring to the expression (1), the ionomer coverage ratio θ is a ratio of the area in which the catalyst metal is in contact with the solid proton conductor (S_{C-S}) to the sum of the area in which the catalyst metal is in contact with the solid proton conductor (S_{C-S}) and the area in which the catalyst metal is in contact with the liquid proton conductor (S_{C-L}).

The coverage ratio can be calculated by, for example, obtaining electric double layer capacitances formed on a catalyst-solid proton conductor interface and a catalyst-liquid proton conductor interface in a state in which the liquid proton conductor is filled in a liquid conductor holding portion of the support. An electric double layer capacitance is in proportion to the area of an electrochemically effective interface. Therefore, an electric double layer capacitance formed on the catalyst-solid proton conductor interface is (S_{C-S}), and an electric double layer capacitance formed on the catalyst-liquid proton conductor interface is (S_{C-L}).

Here, a method for measuring the electric double layer capacitance formed on each of the catalyst-solid proton conductor interface and the catalyst-liquid proton conductor interface will be described.

In a catalyst layer, the following four interfaces can contribute as electric double layer capacitances (Cdl):
(1) a catalyst metal-solid proton conductor interface (C-S);
(2) a catalyst metal-liquid proton conductor interface (C-L);
(3) a porous support-solid proton conductor interface (Cr-S); and
(4) a porous support-liquid proton conductor interface (Cr-L).

Since the electric double layer capacitance is in proportion to the area of an electrochemically effective interface as described above, an electric double layer capacitance on the catalyst metal-solid proton conductor interface (Cdl_{C-S}) and an electric double layer capacitance on the catalyst metal-liquid proton conductor interface (Cdl_{C-L}) may be obtained. Values of these (Cdl_{C-S}) and (Cdl_{C-L}) are used respectively as (S_{C-S}) and (S_{C-L}).

The contributions of the four interfaces to the electric double layer capacitance (Cdl) can be separated as follows.

First, electric double layer capacitances are measured respectively under a high humidity condition such as a relative humidity of 100% RH, and under a low humidity condition such as a relative humidity of 10% RH or less. As a method for measuring an electric double layer capacitance, cyclic voltammetry, electrochemical impedance spectroscopy, or the like can be employed. Through comparison between these electric double layer capacitances, the contribution of the liquid proton conductor (“water” in this case), namely, the contributions of the interfaces (2) and (4) described above, can be separated from those of the interfaces (1) and (3).

Besides, the catalyst metal is deactivated, for example, when Pt is used as the catalyst metal, Pt is deactivated by supplying CO gas to an electrode to be measured to cause CO to adsorb on the surface of the Pt. Thus, the contribution of the Pt to the electric double layer capacitance can be separated. In this deactivated state, the electric double layer capacitances under the high humidity and low humidity conditions as described above are measured by the same method, and thus, the contribution of the Pt, namely, the contributions of the interfaces (1) and (2), can be separated from those of the interfaces (3) and (4).

In this manner, the contributions of all the interfaces (1) to (4) can be separated, and the electric double layer capacitances formed on both the interfaces of the catalyst metal with the solid proton conductor and the liquid proton conductor can be obtained.

Specifically, a measured value obtained in the high humidity state (referred to as the measured value A) is the electric double layer capacitance formed on all the interfaces (1) to (4). This value is substantially the value of all the electric double layer capacitances formed on both the interfaces of the catalyst metal with the solid proton conductor and the liquid proton conductor in the entire catalyst layer. On the other hand, a measured value obtained in the low humidity state (referred to as the measured value B) is the electric double layer capacitances formed on the interfaces (1) and (3). Besides, a measured value obtained in the catalyst deactivated and high humidity state (referred to as the measured value C) is the electric double layer capacitance formed on the interfaces (3) and (4), and a measured value obtained in the catalyst deactivated and low humidity state (referred to as the measured value D) is the electric double layer capacitance formed on the interface (3).

Accordingly, a difference between the measured value A and the measured value C is the electric double layer capacitance formed on the interfaces (1) and (2), and a difference between the measured value B and the measured value D is the electric double layer capacitance formed on the interface (1). Then, by calculating a difference between these values, (A-C)-(B-D), the electric double layer capacitance formed on the interface (2) can be obtained.

In summary, the electric double layer capacitance on the interface between the catalyst metal and the liquid proton conductor can be obtained by subtracting the value of the electric double layer capacitance measured in the low humidity state from the value of the electric double layer capacitance measured in the high humidity state.

Besides, the electric double layer capacitance on the interface between the catalyst metal and the solid proton conductor, and the electric double layer capacitance on the interface between the catalyst metal and the liquid proton conductor can be obtained by measuring the electric double layer capacitance after deactivating the catalyst metal through adsorption of carbon monoxide to the catalyst metal, and subtracting the electric double layer capacitance obtained after the deactivation from the entire electric double layer capacitance obtained before the deactivation.

Then, these operations are combined to subtract the measured value of the electric double layer capacitance obtained in the catalyst deactivated and low humidity state from the measured value of the electric double layer capacitance obtained in the catalyst deactivated and high humidity state, and thus, the value of the electric double layer capacitance only on the interface between the catalyst metal and the solid proton conductor can be obtained.

The contact area between the catalyst metal and the solid proton conductor, and an area exposed to the conductor holding portion can be obtained, for example, by transmission electron microscope (TEM) tomography or the like in addition to by the above-described method.

The above-described method for calculating the coverage ratio of the catalyst metal with the solid proton conductor using the electric double layer capacitance can be simplified. As described above, regarding the interfaces (1) to (4), the measured value A obtained in the high humidity state corresponds to the electric double layer capacitance formed on all the interfaces (1) to (4). On the other hand, the measured value B obtained in the low humidity state corresponds to the electric double layer capacitance formed on the interfaces (1) and (3). In other words, the measured value A obtained in the high humidity state includes a total area (S_{C-S}+S_{C-L}) of both the catalyst metal-solid proton conductor interface (C-S) and the catalyst metal-liquid proton conductor interface (C-L). On the other hand, the measured value B obtained in the low humidity state includes the area (S_{C-S}) of the catalyst metal-solid proton conductor interface (C-S) but does not include the area (S_{C-L}) of the catalyst metal-liquid proton conductor interface (C-L). Therefore, it can be regarded that the measured value B/measured value A substantially approximates the coverage ratio θ=S_{C-S}/(S_{C-S}+S_{C-L}).

When this simplified method is employed, there is no need to cause the deactivated state with CO, and the measurement can be more rapidly performed.

The cathode catalyst layer of the present embodiment includes, between the catalyst metal and the solid proton conductor, the liquid proton conductor capable of connecting the catalyst metal and the solid proton conductor in a state capable of proton conduction at least at the time of the measurement of the ionomer coverage ratio. Since the liquid proton conductor is thus introduced, a proton transport pathway through the liquid proton conductor is ensured between the catalyst metal and the solid proton conductor, and thus, a proton necessary for power generation can be efficiently transported to the surface of the catalyst metal. This liquid proton conductor may be disposed between the catalyst metal and the solid proton conductor at least at the time of the measurement of the ionomer coverage ratio, and can be disposed in a pore (secondary pore) between the porous supports present in the catalyst layer, or in a pore (micropore or mesopore: primary pore) present in the porous support.

The liquid proton conductor is not especially limited as long as it has ionic conductivity, and can exhibit a function of forming a proton transport pathway between the catalyst metal and the solid proton conductor. Specific examples include water, a protic ionic liquid, a perchloric acid aqueous solution, a nitric acid aqueous solution, a formic acid aqueous solution, and an acetic acid aqueous solution.

When water is used as the liquid proton conductor, the water used as the liquid proton conductor can be introduced into the catalyst layer by wetting the catalyst layer with a small amount of liquid water or a humidifying gas before starting the power generation. Alternatively, water generated through the electrochemical reaction occurring in the operation of the fuel cell can be used as the liquid proton conductor. Accordingly, when the operation of the fuel cell is to be started, it is not always necessary to hold the liquid proton conductor. In embodiments, for example, a distance between the surfaces of the catalyst metal and the solid proton conductor may be 0.5 nm or more. When such a distance is kept, water (liquid proton conductor) can be provided between the catalyst metal and the solid proton conductor (liquid conductor holding portion) with retaining the non-contact state between the catalyst metal and the solid proton conductor, and thus, the proton transport pathway using the water can be ensured therebetween.

In embodiments, when a substance except for water, such as an ionic liquid, is used as the liquid proton conductor, it is desirable that the ionic liquid, the solid proton conductor, and the catalyst are dispersed in a solution in producing a catalyst ink, and the ionic liquid may be added in applying the catalyst ink to a catalyst layer base material.

In embodiments, the content of the ionomer in the cathode catalyst layer is not limited as long as the ionomer coverage ratio of the catalyst metal in the cathode catalyst layer falls in the above-described range, and is, for example, 20 to 60% by mass, or 25 to 40% by mass based on the total mass of the cathode catalyst layer. When the content of the ionomer in the cathode catalyst layer is in this range, the ionomer coverage ratio of the catalyst metal in the cathode catalyst layer can be appropriately controlled.

In embodiments, a mass ratio (I/C), in the cathode catalyst layer, between the ionomer and the support used in the electrode catalyst, particularly a carbon support is not limited as long as the ionomer coverage ratio of the catalyst metal in the cathode catalyst layer falls in the above-described range, and is 0.5 to 1.0, 0.6 to 0.9, 0.7 to 0.9, or 0.7 to 0.8. When the mass ratio falls in this range, the ionomer coverage ratio of the catalyst metal in the cathode catalyst layer can be appropriately controlled, and as the mass ratio is lower, the ionomer coverage ratio tends to be lower.

The thickness (dried film thickness) of the catalyst layer is, for example, 0.05 to 30 μm. This thickness is applicable to both the cathode catalyst layer and the anode catalyst layer.

The ionomer coverage ratio can be appropriately controlled to a desired range by adjusting, for example, the content of the ionomer, the composition of the catalyst layer, mixing conditions, and the like.

The anode catalyst layer functions as a fuel electrode, namely, a hydrogen electrode.

The anode catalyst layer contains an electrode catalyst, and an ionomer as an electrolyte. In embodiments, the ionomer is an ionomer having a sulfonic acid group. Examples of the ionomer having a sulfonic acid group include those described above. In one embodiment, the anode catalyst layer can contain, in addition to the electrode catalyst and the ionomer, a metal ion selected from a cerium ion and a manganese ion, and a host compound (such as a crown ether) capable of forming a clathrate compound together with the metal ion.

The electrode catalyst is not especially limited, and for example, the above-described materials can be used.

In embodiments, the content of the catalyst metal in the electrode catalyst of the anode catalyst layer is not limited as long as the above-described catalytic effect is exhibited, and is, for example, 10 to 70% by mass, or 15 to 50% by mass based on the total mass of the electrode catalyst. Alternatively, in embodiments, the content of the catalyst metal in the electrode catalyst of the anode catalyst layer is 0.01 to 2.0 mg/cm², or 0.1 to 0.5mg/cm² per unit area of the anode catalyst layer.

In embodiments, the content of the electrode catalyst in the anode catalyst layer is not especially limited, and is, for example, 3 to 40% by mass, or 5 to 38% by mass based on the total mass of the anode catalyst layer.

The ionomer having a sulfonic acid group is not especially limited, and an example includes a polymer electrolyte resin having ionic conductivity such as a perfluorosulfonic acid ionomer. Specific examples of the ionomer having a sulfonic acid group include Nafion, and Aquivion (Solvay).

In embodiments, a mass ratio (I/C), in the anode catalyst layer, between the ionomer and the support used in the electrode catalyst, particularly, the carbon support is not especially limited, and is 0.5 to 1.2, or 0.7 to 1.0. When the mass ratio is set to fall in this range, good adhesion between the catalyst layer and the electrolyte membrane, and proton conductivity can be ensured.

The membrane electrode assembly of the present embodiment contains a metal ion selected from a cerium ion and a manganese ion, and a host compound capable of forming a clathrate compound together with the metal ion. The cerium ion and/or the manganese ion functions as a radical quencher to capture and make harmless a hydrogen peroxide radical, and hence can suppress the deterioration of the membrane electrode assembly. Besides, the host compound (such as a crown ether) to the metal ion can suppress movement of the metal ion when added to the membrane electrode assembly, and can reduce deviation of the concentration in the plane direction.

The metal ion is selected from a cerium ion and a manganese ion. The cerium ion and the manganese ion function as a radical quencher. The radical quencher can ease conversion, into a hydroxide ion, of a hydroxyl radical generated from hydrogen peroxide, and can suppress deterioration of the anode catalyst layer. For example, a reaction from a hydroxyl radical to a hydroxide ion caused by a cerium ion is as follows:

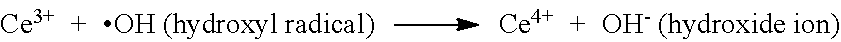

The cerium ion may be positive trivalent, or positive tetravalent. The manganese ion may be positive trivalent, or positive tetravalent.

A cerium salt used for obtaining the cerium ion is not especially limited, and examples thereof include cerium nitrate, cerium carbonate, cerium acetate, cerium chloride, cerium sulfate, diammonium cerium nitrate, and tetraammonium cerium sulfate. One of these cerium salts may be singly used, or two or more of these may be used in combination. The cerium salt may be an organic metal complex salt. An example of the organic metal complex salt includes cerium acetylacetonate.

A manganese salt used for obtaining the manganese ion is not especially limited, and examples thereof include manganese nitrate, manganese carbonate, manganese acetate, manganese chloride, and manganese sulfate. One of these manganese salts may be singly used, or two or more of these may be used in combination.

The host compound of the present embodiment forms a clathrate compound together with the cerium ion or the manganese ion serving as a guest compound. The clathrate compound refers to an addition compound in a form in which the metal ion serving as the guest compound is included in the host compound. Examples of the host compound forming a clathrate compound include a crown ether compound, a cyclodextrin compound, a cyclophane compound, and salts of these. One of these host compounds may be singly used, or two or more of these may be used in combination.

The host compound is not especially limited as long as it is a compound capable of forming a clathrate compound together with the metal ion. In embodiments, the host compound has a cyclic structure, and the number of ring members of the cyclic structure is 15 or more, or 18 or more. In one embodiment, the host compound is a crown ether compound or a salt thereof. The crown ether compound is a compound containing a ring having a repeating structure of a (-CH₂-CH₂-Y-) unit or a (-CH₂-CH₂-CH₂-Y-) unit, wherein Y is at least one hetero atom selected from O, S, N, and P. The crown ether compound captures the metal ion in this ring structure to form a clathrate compound. In embodiments, the number of ring members of the crown ether compound is 15 or more, or 18 or more. The crown ether compound forms a clathrate compound together with a cerium ion or a manganese ion serving as a guest compound. The clathrate compound refers to an addition compound in a form in which the metal ion serving as the guest compound is included in the host compound. One of these crown ether compounds may be singly used, or two or more of these may be used in combination.

Examples of the crown ether compound include a crown ether, and a crown ether derivative. Examples of the crown ether include 15-crown-5-ether, 18-crown-6-ether, 21-crown-7-ether, and 24-crown-8-ether. In the present embodiment, the host compound is a crown ether compound having an aromatic ring or an aliphatic ring. The crown ether compound having an aromatic ring or an aliphatic ring has high hydrophobicity due to the structure thereof, and hence minimally moves to the cathode catalyst layer. Examples of the crown ether compound having an aromatic ring or an aliphatic ring include dibenzo-15-crown-5-ether, benzo-18-crown-6-cther, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, dicyclohexano-24-crown-8-cther, and a compound obtained by substituting the aromatic ring or the aliphatic ring of any of these compounds with at least one substituent selected from a halogen atom (such as a fluorine atom or a bromine atom), a hydroxy group, an amino group, a nitro group, a formyl group, an alkyl group having 1 to 6 carbon atoms (such as a methyl group, an ethyl group, a propyl group, or a butyl group), a hydroxyalkyl group having 1 to 6 carbon atoms, a carboxyalkyl group having 2 to 7 carbon atoms, and an aryl group having 6 to 14 carbon atoms (such as a phenyl group). The number of substituents is, for example, 1 to 6, 1 to 5, 1 to 4, 1 to 3, 1 to 2, or 1. One of these compounds may be singly used, or two or more of these may be used in combination.

In the present embodiment, the host compound is a crown ether compound having a molecular weight of 300 or more, or a salt thereof. When a crown ether compound having a molecular weight of 300 or more is used, an effect of suppressing movement can be obtained, namely, movement of the crown ether compound from the anode catalyst layer or the electrolyte membrane to the cathode catalyst layer can be suppressed.

Examples of the salt of the crown ether compound include a nitric acid salt, a sulfuric acid salt, a carbonic acid salt, an acetic acid salt, and a propionic acid salt. One of these salts may be singly used, or two or more of these may be used in combination.

The host compound and the metal ion can be contained in the anode catalyst layer, the solid polymer electrolyte membrane, or both of these. In the anode catalyst layer of the membrane electrode assembly of one embodiment, at least a part of the host compound and the metal ion form the clathrate compound.

When the anode catalyst layer contains the host compound and the metal ion, the anode catalyst layer contains at least the electrode catalyst, the ionomer as the electrolyte, the metal ion selected from a cerium ion and a manganese ion, and the host compound. The metal ion can case conversion, into a hydroxide ion, of a hydroxyl radical generated from hydrogen peroxide, and can suppress deterioration of the anode catalyst layer.

In embodiments, the content of the metal ion and the host compound in the anode catalyst layer is 0.1 to 20% by mass based on a total solid content of the anode catalyst layer. In considering this content, the clathrate compound is regarded as a mixture of the metal ion and the host compound. In other words, when the metal ion and the host compound are separately added or simply mixed to be added to the anode catalyst layer, even if the clathrate compound is produced in the polymer electrolyte, the amount of this clathrate compound is not taken into consideration, but only the total amount of the metal ion and the host compound mixed is considered for the calculation. Alternatively, when a clathrate compound is precedently formed, and the clathrate compound is then added to the anode catalyst layer, the amount of this clathrate compound is regarded as the total amount of the metal ion and the host compound used for forming the clathrate compound. Besides, when a metal ion and a host compound not forming the clathrate compound are present in addition to the metal ion and the host compound used for forming the clathrate compound, the metal ion and the host compound not forming the clathrate compound are also taken into consideration for the calculation.

In embodiments, the content of the metal ion in the anode catalyst layer is 0.1 to 20 μg/cm². In embodiments, the content of the host compound in the anode catalyst layer is 0.1 to 20 μg/cm².

As for a relative ratio between the metal ion and the host compound in the present embodiment, a molar ratio of the host compound to the metal ion ([number of moles of host compound]/[number of moles of metal ion]) is, in embodiments, for example, 0.1 to 10, 0.2 to 7.5, or 0.4 to 5.0. In embodiments, in other words, the content of the host compound is, for example, 0.1 to 10 moles, 0.2 to 7.5 moles, or 0.4 to 5.0 moles per mole of the metal ion. Also in considering this relative ratio, the clathrate compound is regarded as the mixture thereof in the same way.

When a solid polymer electrolyte membrane contains a host compound and a metal ion, the solid polymer electrolyte membrane containing a host compound and a metal ion can be obtained by, for example, any of the following methods:
(1) A method in which a solid polymer electrolyte membrane is immersed in a solution containing a metal ion for ion-exchanging a group such as a sulfonic acid group with the metal ion, and then the resultant is immersed in a solution containing a host compound to cause the host compound to be contained in the membrane;
(2) a method in which a compound containing a metal ion (such as a cerium salt) is added to a dispersion of a polymer electrolyte for ion-exchanging a group such as a sulfonic acid group with the metal ion, a solution or a solid containing a host compound is added to the resultant dispersion, and the thus obtained solution is used for forming a membrane by coating;
(3) a method in which a compound containing a metal ion (such as a cerium salt) and a host compound are reacted with each other in a solvent to form a clathrate compound, a solid polymer electrolyte membrane is immersed in a solution obtained by dissolving the clathrate compound in a solvent for ion-exchanging a group such as a sulfonic acid group with the clathrate compound, and thus the clathrate compound is caused to be contained in the membrane; and
(4) a method in which a compound containing a metal ion (such as a cerium salt) and a host compound are reacted with each other in a solvent to form a clathrate compound, the clathrate compound or a solution thereof is added to a dispersion of a polymer electrolyte, and the resultant solution is used for forming a membrane by coating.

### Method for Producing Membrane Electrode Assembly

A catalyst layer can be formed, for example, by steps of preparing a catalyst ink (having a solid content concentration of, for example, about 10%) containing an electrode catalyst, an ionomer, and a solvent; applying the catalyst ink to a surface of a base material and vaporizing the solvent from the resultant applied film to form a catalyst layer on the surface of the base material; and transferring the catalyst layer formed on the surface of the base material to an electrolyte membrane. Alternatively, a catalyst layer can be formed by a method for applying the catalyst ink directly to a solid polymer electrolyte membrane instead of the base material. A membrane electrode assembly can be produced by forming a cathode catalyst layer and an anode catalyst layer on the solid polymer electrolyte membrane.

Examples of a method for applying a catalyst ink include a spray method, a blade coating method using a doctor blade or an applicator, a die coating method, a reverse roll coating method, and an intermittent die coating method.

In forming an anode catalyst layer, the catalyst ink used for forming the anode catalyst layer may contain the metal ion and the host compound. Specifically, the catalyst ink used for forming an anode catalyst layer can contain an electrode catalyst, an ionomer (such as an ionomer having a sulfonic acid group), the metal ion, the host compound, and a solvent. The metal ion and the host compound may be separately added, or may be added in the form of a complex thereof.

In the present embodiment, the cathode catalyst layer is formed so that the ionomer coverage ratio of the catalyst metal in the cathode catalyst layer can be 40% or less. The ionomer coverage ratio can be appropriately controlled to fall in a desired range by adjusting, for example, but not limited to, the content of the ionomer, the composition of the catalyst layer, mixing conditions and the like.

Specific Structures of Membrane Electrode Assembly and Polymer Electrolyte Fuel Cell

A polymer electrolyte fuel cell has, as a basic unit, a membrane electrode assembly (MEA) in which catalyst layers (electrodes) are bonded to both surfaces of a solid polymer electrolyte membrane. Besides, in the polymer electrolyte fuel cell, a gas diffusion layer is generally disposed outside the catalyst layer. The gas diffusion layer is used for supplying a reaction gas and an electron to the catalyst layer, and uses carbon paper, carbon cloth, or the like. Besides, the catalyst layer is a portion corresponding to a reaction field of an electrode reaction.

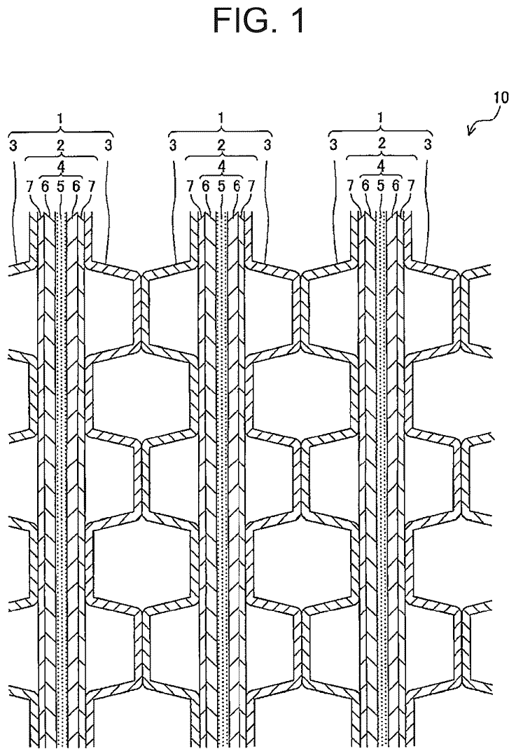

Now, referring to FIG. 1, the structure of a membrane electrode assembly and a polymer electrolyte fuel cell will be described. FIG. 1 is a schematic sectional view for illustrating a structural example of a polymer electrolyte fuel cell of the present embodiment, and is a sectional view of a main part of an exemplified fuel cell 10. The polymer electrolyte fuel cell includes a stack of single cells each including a power generator, and a fuel cell separator disposed on both sides of the power generator. The single cells are stacked in a stacking direction, and are electrically connected in series. As illustrated in FIG.

1, the fuel cell 10 includes a plurality of stacked single cells 1, that is, a basic unit. Each single cell 1 is a polymer electrolyte fuel cell that generates electromotive force through an electrochemical reaction between an oxidant gas (such as air) and a fuel gas (such as hydrogen). Each single cell 1 includes a membrane electrode & gas diffusion layer assembly (MEGA) 2 having a gas diffusion layer (GDL) 7 disposed on both sides, and a separator 3 in contact with the MEGA 2 for partitioning the MEGA 2. In the present embodiment, the MEGA 2 is sandwiched between a pair of separators 3.

The MEGA 2 includes a membrane electrode assembly (MEA) 4, and gas diffusion layers 7 disposed on both sides thereof. The membrane electrode assembly 4 includes an electrolyte membrane 5, and a pair of electrodes 6 bonded to sandwich the electrolyte membrane 5. The electrolyte membrane 5 is, for example, a proton-conductive ion-exchange membrane formed from a solid polymer material. The electrode 6 contains, for example, a porous carbon material in which a catalyst such as platinum is supported. One of the electrodes 6 disposed on one side of the electrolyte membrane 5 functions as an anode, and the other electrode 6 disposed on the other side functions as a cathode. The gas diffusion layer 7 is formed from a conductive member having gas permeability. Examples of the conductive member having gas permeability include a carbon porous material such as carbon paper or carbon cloth, and a metal porous material such as a metal mesh or a foam metal. In the present embodiment, an anode electrode is constituted by an anode catalyst layer, and a cathode electrode is constituted by a cathode catalyst layer.

Now, the present embodiment will be described by way of examples.

### Production Example 1: Electrode Catalyst

### Preparation of Platinum-Supported Catalyst A

A platinum-supported catalyst A containing a Pt particle as a catalyst metal, and carbon black (VULCAN, manufactured by Cabot Corporation) as a support supporting the metal particle was prepared (metal supporting ratio: 36% by mass). In the platinum-supported catalyst A, a peak pore size was 11.5 nm, a mesopore volume of pores of 2 to 30 nm was 1.9 cc/g, and a BET specific surface area was 159.0 m²/g.

### Preparation of Platinum-Supported Catalyst B

A platinum-supported catalyst B containing a Pt particle as a catalyst metal, and Ketchen black (product name: EC300J, manufactured by LION SPECIALTY CHEMICALS CO., LTD.) as a support supporting the metal particle was prepared (metal supporting ratio: 42% by mass). In the platinum-supported catalyst B, a peak pore size was 5.4 nm, a mesopore volume of pores of 2 to 30 nm was 10.5 cc/g, and a BET specific surface area was 458.0 m²/g.

### Preparation of Platinum-Supported Catalyst C

A platinum-supported catalyst C containing a Pt particle as a catalyst metal, and carbon black as a support supporting the metal particle was prepared (metal supporting ratio: 48% by mass). In the platinum-supported catalyst C, a peak pore size was 3.5 nm, a mesopore volume of pores of 2 to 30 nm was 14.0 cc/g, and a BET specific surface area was 708.0 m²/g.

### Production Example 2: Clathrate Compound (complex: Ce-Ligand)

### Preparation of Complex A (Ce-B18CRE)

Benzo-18-crown-6-ether (also referred to as B18CRE) (3.12 g, 0.01 mol) and cerium nitrate (III) hexahydrate (4.34 g, 0.01 mol) were weighed in a 100 mL eggplant flask, and ethanol (20 mL) and water (20 mL) were added thereto, followed by stirring at room temperature for 24 hours. Thereafter, a solution was removed with an evaporator, and the resultant was vacuum dried at 60° C. for 1 hour to obtain a white solid (complex A). It was confirmed by FT-IR that a peak derived from an ether group had shifted to a lower wavenumber side, and thus it was confirmed that the crown ether compound included Ce.

### Preparation of Complex B (Ce-18CRE)

18-Crown-6-ether (18CRE) (2.64 g, 0.01 mol) and cerium nitrate (III) hexahydrate (4.34 g, 0.01 mol) were weighed in a 100 mL eggplant flask, and ethanol (20 mL) and water (20 mL) were added thereto, followed by stirring at room temperature for 24 hours. Thereafter, a solution was removed with an evaporator, and the resultant was vacuum dried at 60° C. for 1 hour to obtain a white solid (complex B). It was confirmed by FT-IR that a peak derived from an ether group had shifted to a lower wavenumber side, and thus it was confirmed that the CRE and Ce had together formed a clathrate compound.

### Example 1

### Formation of Cathode Catalyst Layer

A catalyst ink was prepared by dispersing, with a bead mill, the platinum- supported catalyst A used as the electrode catalyst in an ionomer solution (Nafion DE2020) containing water and ethanol. The water/alcohol mass ratio in the catalyst ink was set to about 1. The catalyst ink was coated on a polytetrafluoroethylene sheet, and the resultant was dried to form a cathode catalyst layer.

The Pt coating mass of the cathode catalyst layer was set to 0.2 mg/cm², and the mass ratio (I/C) between the ionomer and the support was set to 0.9. The ionomer coverage ratio of the catalyst metal in the cathode catalyst layer measured by a method described below was 40%.

### Formation of Anode Catalyst Layer

A platinum-supported carbon catalyst (TEC10E30E, 30% platinum-supported carbon, manufactured by TANAKA PRECIOUS METAL TECHNOLOGIES Co., Ltd.) was used as the electrode catalyst. A catalyst ink was prepared by dispersing the electrode catalyst and the complex A in an ionomer solution (DE2020) containing water, ethanol, and Nafion (registered trademark). The catalyst ink was coated on a polytetrafluoroethylene sheet, and the resultant was dried to form an anode catalyst layer.

The Pt coating mass of the anode catalyst layer was set to 0.1 mg/cm², and the cerium ion concentration was set to 6 μg/cm². The crown ether compound was added by the above-described method in a molar ratio of Ce:ligand of 1:1. The concentration of the crown ether compound was 13.5 μg/cm². The mass ratio (I/C) between the ionomer and carbon was set to 1.0.

### Production of Membrane Electrode Assembly

The thus obtained cathode catalyst layer and anode catalyst layer were thermally transferred respectively to both surfaces of a Nafion (registered trademark) membrane (NR211) to produce a membrane electrode assembly El. The thermal transfer was performed under conditions of 140°° C., 50 kgf/cm² (4.90 MPa), and 5 minutes. The electrode area of a membrane electrode assembly for initial performance test, and for durability test was set to 3.6 cm x 3.6 cm (12.96 cm²). The membrane electrode assembly was sandwiched between paper diffusion layers (GDL) having a water-repellent layer to produce a test cell.

### Example 2

A membrane electrode assembly E2 was produced in the same manner as in Example 1 except that the mass ratio (I/C) between the ionomer and the support in the cathode catalyst layer was changed to 0.8. The ionomer coverage ratio of the catalyst metal in the cathode catalyst layer measured by the method described below was 36%.

### Example 3

A membrane electrode assembly E3 was produced in the same manner as in Example 1 except that the mass ratio (I/C) between the ionomer and the support in the cathode catalyst layer was changed to 0.7. The ionomer coverage ratio of the catalyst metal in the cathode catalyst layer measured by the method described below was 33%.

### Example 4

A membrane electrode assembly E4 was produced in the same manner as in Example 1 except that the platinum-supported catalyst B was used instead of the platinum-supported catalyst A, and that the mass ratio (I/C) between the ionomer and the support in the cathode catalyst layer was changed to 1.0. The ionomer coverage ratio of the catalyst metal in the cathode catalyst layer measured by the method described below was 10%.

### Example 5

A membrane electrode assembly E5 was produced in the same manner as in Example 1 except that the platinum-supported catalyst C was used instead of the platinum-supported catalyst A, and that the mass ratio (I/C) between the ionomer and the support in the cathode catalyst layer was changed to 1.0. The ionomer coverage ratio of the catalyst metal in the cathode catalyst layer measured by the method described below was 28%.

### Example 6

A membrane electrode assembly E6 was produced in the same manner as in Example 1 except that the complex B was used instead of the complex A. The ionomer coverage ratio of the catalyst metal in the cathode catalyst layer measured by the method described below was 40%.

### Example 7

A membrane electrode assembly E7 was produced in the same manner as in Example 2 except that the complex B was used instead of the complex A. The ionomer coverage ratio of the catalyst metal in the cathode catalyst layer measured by the method described below was 36%.

### Example 8

A membrane electrode assembly E8 was produced in the same manner as in Example 3 except that the complex B was used instead of the complex A. The ionomer coverage ratio of the catalyst metal in the cathode catalyst layer measured by the method described below was 33%.

### Comparative Example 1

A membrane electrode assembly C1 was produced in the same manner as in Example 1 except that the complex was not added to the anode catalyst layer, and that the mass ratio (I/C) between the ionomer and the support in the cathode catalyst layer was changed to 1.0. The ionomer coverage ratio of the catalyst metal in the cathode catalyst layer measured by the method described below was 47%.

### Comparative Example 2

A membrane electrode assembly C2 was produced in the same manner as in Example 1 except that the mass ratio (I/C) between the ionomer and the support in the cathode catalyst layer was changed to 1.0. The ionomer coverage ratio of the catalyst metal in the cathode catalyst layer measured by the method described below was 47%.

### Comparative Example 3

A membrane electrode assembly C3 was produced in the same manner as in Example 1 except that the complex was not added to the anode catalyst layer. The ionomer coverage ratio of the catalyst metal in the cathode catalyst layer measured by the method described below was 40%.

### Comparative Example 4

A membrane electrode assembly C4 was produced in the same manner as in Example 2 except that the complex was not added to the anode catalyst layer. The ionomer coverage ratio of the catalyst metal in the cathode catalyst layer measured by the method described below was 36%.

### Comparative Example 5

A membrane electrode assembly C5 was produced in the same manner as in Example 3 except that the complex was not added to the anode catalyst layer. The ionomer coverage ratio of the catalyst metal in the cathode catalyst layer measured by the method described below was 33%.

### Comparative Example 6

A membrane electrode assembly C6 was produced in the same manner as in Example 4 except that the complex was not added to the anode catalyst layer. The ionomer coverage ratio of the catalyst metal in the cathode catalyst layer measured by the method described below was 10%.

### Comparative Example 7

A membrane electrode assembly C7 was produced in the same manner as in Example 5 except that the complex was not added to the anode catalyst layer. The ionomer coverage ratio of the catalyst metal in the cathode catalyst layer measured by the method described below was 28%.

### Comparative Example 8

A membrane electrode assembly C8 was produced in the same manner as in Comparative Example 2 except that the complex B was used instead of the complex A. The ionomer coverage ratio of the catalyst metal in the cathode catalyst layer measured by the method described below was 47%.

### Measurement of Ionomer Coverage Ratio of Catalyst Metal

The thus obtained membrane electrode assemblies E1 to E8 and C1 to C8 were measured for a coverage ratio, that is, a ratio of the catalyst metal covered with the solid proton conductor (ionomer). The coverage ratio was measured by measuring, as described above in the embodiment, electric double layer capacitances formed on interfaces of the catalyst with the solid proton conductor and the liquid proton conductor (water).

A single cell for a test (electrode area: 1 cm²) using each of the obtained membrane electrode assemblies was produced for evaluation. As the structure of the single cell used in this example, separators having gas passages were disposed on both sides of the membrane electrode assembly for sandwiching the assembly, current collector plates were disposed outside (on both sides) of the separators, and end plates were disposed further outside. To this single cell, a gas piping necessary for evaluations (measurements) described below was attached. The gas piping was provided so that the pressure, the temperature, and the humidity could be adjusted. Besides, wirings were provided to the current collector plates from a potentiostat so as to be on an anode side and a cathode side.

In each of the membrane electrode assemblies E1 to E8 and C1 to C8, electric double layer capacitances were measured by electrochemical impedance spectroscopy in an activated state (before deactivation) and in a high humidity state (100% RH), and a low humidity state (5% RH). Besides, electric double layer capacitances were measured in a catalyst deactivated state and in the high humidity state (100% RH) and the low humidity state (5% RH).

As apparatuses, Electrochemical Measurement System HZ-3000manufactured by Hokuto Denko Co., Ltd., and Frequency Response Analyzer FRA5020manufactured by NF Corporation were used, the evaluation was performed under the above-described humidities under conditions of a cell temperature of 30° C., a frequency range of 20 kHz to 10 mHz, an amplitude of +10 mV, a holding potential of 0.45 V, and supplied gasses of hydrogen/nitrogen (counter electrode/working electrode).

### Performance Evaluations

### Initial Performance Test

The membrane electrode assembly (electrode area: 12.96 cm²) was used for performing cell evaluation. A current-voltage characteristic was evaluated under a low humidity condition (cell temperature: 95° C., humidity: 30% RH) to measure performance (voltage) at 1.5 A/cm². The sweep rate in evaluating the current-voltage characteristic was set to 20 mA/s, and the characteristic was obtained through anodic sweeping. A cell pressure was set to 150 kPa, hydrogen was used as anode gas, the flow rate of the anode gas was set to 1.0 L/min, air was used as cathode gas, and the flow rate of the cathode gas was set to 2.0 L/min. The results are shown in Table 1. Besides, voltage reduction at 1.5 A/cm² caused by addition of crown ether in employing a combination of each catalyst and crown ether is shown as a difference in initial voltage in Table 1.

### Durability Test: Voltage Reduction Ratio

The test cell (electrode area: 12.96 cm²) was used to perform a durability test under a low humidity environment (cell temperature: 95° C., humidity: 30% RH) where the electrolyte membrane is easily deteriorated, and at a low current density (0.2 A/cm²) for 300 hours. A cell pressure was set to 150 kPa, hydrogen was used as anode gas, the flow rate of the anode gas was set to 1.0 L/min, air was used as cathode gas, and the flow rate of the cathode gas was set to 2.0 L/min. After the durability test, hydrogen/air was supplied to evaluate properties of the polymer electrolyte fuel cell at a current density of 1.5 A/cm² under the conditions of the initial performance test described above, and a cell voltage at the initial stage of an operation, and the relationship between the elapsed time after starting the operation and the cell voltage was determined. The results are shown in Table 1.

It is understood, from Table 1, in embodiments, that when the ionomer coverage ratio of the catalyst metal in the cathode catalyst layer is 40% or less, 36% or less, or 33% or less, the voltage reduction caused through the use is suppressed as well as the reduction of the initial voltage can be also suppressed.

TABLE 1

| | | | | Com. | Com. | Com. | | Com. | | Com. | |
|---|---|---|---|---|---|---|---|---|---|---|---|
| | | Struc- | | Ex. | Ex. | Ex. | Ex. | Ex. | Ex. | Ex. | Ex. |
| | | ture | Unit | 1 | 2 | 3 | 1 | 4 | 2 | 5 | 3 |
| Additive | Crown | B18CRE | ug/cm² | — | 13.5 | — | 13.5 | — | 13.5 | — | 13.5 |
| to Anode | Ether | 18CRE | ug/cm² | — | — | — | — | — | — | — | — |
| Catalyst | Cerium | Cerium | ug/cm² | 6 | 6 | 6 | 6 | 6 | 6 | 6 | 6 |
| Layer | Nitrate | | | | | | | | | | |
| Cathode | Ionomer | DE2020 | I/C | 1.0 | 1.0 | 0.9 | 0.9 | 0.8 | 0.8 | 0.7 | 0.7 |
| Catalyst | | | (mass ratio) | | | | | | | | |
| Layer | Cathode | Catalyst | Ionomer | 47% | 47% | | | | | | |
| | Catalyst | A I/C | Coverage | | | | | | | | |
| | | 1.0 | Ratio (%) | | | | | | | | |
| | | Catalyst | Ionomer | | | 40% | 40% | | | | |
| | | A I/C | Coverage | | | | | | | | |
| | | 0.9 | Ratio (%) | | | | | | | | |
| | | Catalyst | Ionomer | | | | | 36% | 36% | | |
| | | A I/C | Coverage | | | | | | | | |
| | | 0.8 | Ratio (%) | | | | | | | | |
| | | Catalyst | Ionomer | | | | | | | 33% | 33% |
| | | A I/C | Coverage | | | | | | | | |
| | | 0.7 | Ratio (%) | | | | | | | | |
| | | Catalyst | Ionomer | | | | | | | | |
| | | B I/C | Coverage | | | | | | | | |
| | | 1.0 | Ratio (%) | | | | | | | | |
| | | Catalyst | Ionomer | | | | | | | | |
| | | C I/C | Coverage | | | | | | | | |
| | | 1.0 | Ratio (%) | | | | | | | | |
| Initial | Initial | 95° C., | mV | 455 | 425 | 441 | 430 | 428 | 423 | 412 | 412 |
| Perfor- | Voltage | 30% RH, | | | | | | | | | |
| mance | | 1.5 A/cm² | | | | | | | | | |
| | Difference | CRE added − | mV | | −30 | | −11 | | −5 | | 8 |
| | in Initial | CRE not added | | | | | | | | | |
| | Voltage | | | | | | | | | | |
| Dura- | Voltage | 95° C., | mV | 405 | 415 | 320 | 416 | 379 | 411 | 379 | 405 |
| bility | after | 30% RH, | | | | | | | | | |
| | Durability | 1.5 A/cm² | | | | | | | | | |
| | Test | | | | | | | | | | |
| | Voltage | | % | 89.0% | 97.6% | 88.4% | 96.7% | 88.6% | 97.2% | 92.0% | 98.3% |
| | Retention | | | | | | | | | | |
| | Rate | | | | | | | | | | |
| | | | | Com. | | Com. | | Com. | | | |
| | | Struc- | | Ex. | Ex. | Ex. | Ex. | Ex. | Ex. | Ex. | Ex. |
| | | ture | Unit | 6 | 4 | 7 | 5 | 8 | 6 | 7 | 8 |
| Additive | Crown | B18CRE | ug/cm² | — | 13.5 | — | 13.5 | — | — | — | — |
| to Anode | Ether | 18CRE | ug/cm² | — | — | — | — | 11.4 | 11.4 | 11.4 | 11.4 |
| Catalyst | Cerium | Cerium | ug/cm² | 6 | 6 | 6 | 6 | 6 | 6 | 6 | 6 |
| Layer | Nitrate | | | | | | | | | | |
| Cathode | Ionomer | DE2020 | I/C | 1.0 | 1.0 | 1.0 | 1.0 | 1.0 | 0.9 | 0.8 | 0.7 |
| Catalyst | | | (mass ratio) | | | | | | | | |
| Layer | Cathode | Catalyst | Ionomer | | | | | 47% | | | |
| | Catalyst | A I/C | Coverage | | | | | | | | |
| | | 1.0 | Ratio (%) | | | | | | | | |
| | | Catalyst | Ionomer | | | | | | 40% | | |
| | | A I/C | Coverage | | | | | | | | |
| | | 0.9 | Ratio (%) | | | | | | | | |
| | | Catalyst | Ionomer | | | | | | | 35% | |
| | | A I/C | Coverage | | | | | | | | |
| | | 0.8 | Ratio (%) | | | | | | | | |
| | | Catalyst | Ionomer | | | | | | | | 33% |
| | | A I/C | Coverage | | | | | | | | |
| | | 0.7 | Ratio (%) | | | | | | | | |
| | | Catalyst | Ionomer | 10% | 10% | | | | | | |
| | | B I/C | Coverage | | | | | | | | |
| | | 1.0 | Ratio (%) | | | | | | | | |
| | | Catalyst | Ionomer | | | 28% | 28% | | | | |
| | | C I/C | Coverage | | | | | | | | |
| | | 1.0 | Ratio (%) | | | | | | | | |
| Initial | Initial | 95° C., | mV | 342 | 544 | 595 | 594 | 411 | 422 | 421 | 410 |
| Perfor- | Voltage | 30% RH, | | | | | | | | | |
| mance | | 1.5 A/cm² | | | | | | | | | |
| | Difference | CRE added − | mV | | 2 | | −1 | −44 | −19 | −7 | −2 |
| | in Initial | CRE not added | | | | | | | | | |
| | Voltage | | | | | | | | | | |
| Dura- | Voltage | 95° C., | mV | 474 | 526 | 522 | 575 | 386 | 404 | 487 | 402 |
| bility | after | 30% RH, | | | | | | | | | |
| | Durability | 1.5 A/cm² | | | | | | | | | |
| | Test | | | | | | | | | | |
| | Voltage | | % | 87.5% | 96.7% | 87.7% | 96.8% | 96.4% | 95.7% | 96.7% | 98.0% |
| | Retention | | | | | | | | | | |
| | Rate | | | | | | | | | | |

The upper limits and/or the lower limits of each numerical range described herein can be arbitrarily combined to specify a desirable range. For example, the upper limits and the lower limits of each numerical range can be arbitrarily combined to specify a desirable range, the upper limits of the numerical range can be arbitrarily combined to specify a desirable range, and the lower limits of the numerical range can be arbitrarily combined to specify a desirable range.

The present embodiment has been described in detail, and it is noted that specific configurations are not limited by this embodiment, but any design changes made without departing from the scope of the present disclosure are also encompassed in the present disclosure.

What is claimed is:

1. A membrane electrode assembly including a solid polymer electrolyte membrane, an anode catalyst layer disposed on a first surface of the solid polymer electrolyte membrane, and a cathode catalyst layer disposed on a second surface of the solid polymer electrolyte membrane, the membrane electrode assembly comprising:
a metal ion selected from a cerium ion and a manganese ion; and
a host compound having an ability of forming a clathrate compound together with the metal ion, wherein:
the cathode catalyst layer contains an electrode catalyst, and an ionomer;
the electrode catalyst is a metal supported catalyst containing a catalyst metal, and a support supporting the catalyst metal; and
an ionomer coverage ratio of the catalyst metal in the cathode catalyst layer is 40% or less.

2. The membrane electrode assembly according to claim 1, wherein the host compound is a crown ether compound or a salt of the crown ether compound.

3. The membrane electrode assembly according to claim 2, wherein the host compound has a molecular weight of 300 or more.

4. The membrane electrode assembly according to claim 2, wherein the host compound is a crown ether compound having an aromatic ring or an aliphatic ring, or a salt of the crown ether compound.

5. The membrane electrode assembly according to claim 1, wherein the ionomer comprises a perfluorosulfonic acid polymer.

6. The membrane electrode assembly according to claim 1, wherein the ionomer comprises a fluorine resin-based ionomer having a sulfonic acid group-containing side chain represented by a general formula:
-(OCF₂CFX)ₘ-Oₚ-(CF₂)ₙ-SO₃H
wherein m represents an integer of 0 to 3, n represents an integer of 0 to 12, p represents 0 or 1, and X represents a fluorine atom or a trifluoromethyl group.

7. The membrane electrode assembly according to claim 1, wherein the catalyst metal of the cathode catalyst layer comprises at least one selected from the group consisting of a platinum particle, a platinum alloy particle, and a composite particle containing platinum.

8. The membrane electrode assembly according to claim 1, wherein the support of the cathode catalyst layer comprises carbon having electronic conductivity or an oxide having electronic conductivity.

9. The membrane electrode assembly according to claim 1, wherein:
a pore volume distribution of the metal supported catalyst has a peak pore size in a range of a pore size of 2.0 nm or more and 12.0 nm or less; and
a pore volume of mesopores of 2 nm to 30 nm of the metal supported catalyst is 1.9 cc/g or more.

10. A fuel cell comprising the membrane electrode assembly according to claim 1.
